(19) United States
(12) Patent Application Publication
(10) Pub. No.: US 2006/0241893 A1
(43) Pub. Date: Oct. 26, 2006

(54) Analysis and annotation of printed time-varying signals

(75) Inventors: Jean-Manuel Van Thong, Arlington, MA (US); Leonidas Kontothanassis, Arlington, MA (US); Paolo Faraboschi, Sant Cugat (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/110,772

(22) Filed: Apr. 21, 2005

(51) Int. Cl. G06F 15/00

(52) U.S. Cl. 702/150

(57) ABSTRACT

A system for analysing and annotating time-varying signals comprises a substrate for carrying the time-varying signal in printed form, a printer for printing the time-varying signal over the substrate and a reading and writing device for reading a local background pattern of the substrate and writing on the substrate, the reading and writing device enabling the position of annotations on the substrate to be determined. Local portions of the background pattern on the substrate uniquely identify a location of the background pattern over the substrate. This enables the position of annotations on the substrate which relate to portions of the signal to be determined. This enables annotations written on the printed plot to be stored digitally. The locations of the markings which define the annotations enable not only the annotations themselves to be recorded, but also the parts of the signal to which they relate.

### FIELD OF THE INVENTION

This invention relates to the analysis and annotation of time-varying signals, in particular the analysis and annotation of time-varying signals provided in the form of paper printouts. Particularly, but not exclusively, the invention relates to the analysis and the annotation of physiological signals.

### BACKGROUND OF THE INVENTION

Many different types of printed signal plots require analysis in order to determine parts of the signal plot of interest. For example, various physiological signals are important in the way they vary over time. Examples are signals measuring heart activity or brain activity, such as the electrocardiogram (ECG) and the electroencephalogram (EEG), as well as signals providing blood flow rate measurements, perspiration levels (for example in a lie detector) and so on.

The recording of these signals typically takes place as a continuous paper print out, and this provides a medium onto which comments may be written, such as diagnostic indications. It is also possible to store the data electronically, but the use of a paper print out is preferred as it enables annotations to be made in an easy, user-friendly manner.

However, this approach requires large volumes of paper to be kept and results in annotations which cannot easily be electronically distributed or centrally stored. The retrieval and browsing of these records is also difficult, as the paper record will only be available for inspection in one location.

In order to store the annotations into an electronic central record, they must be re-written into a different format used for those records. The original paper printouts are also kept as a record of the physiological data and the annotated comments. This results in duplication of effort and the storage of large amounts of paper records, which may only have small amounts of interesting data.

### SUMMARY OF THE INVENTION

According to the invention, there is provided a substrate for carrying a printed time-varying signal, wherein the substrate carries a background pattern, in which local portions of the background pattern uniquely identify a location of the background pattern over the substrate, thereby enabling the position of annotations on the substrate which relate to portions of the signal to be determined.

This enables annotations written on a print out of a time-varying signal, such as a physiological signal, to be stored digitally. The locations of the markings which define the annotations enable not only the annotations themselves to be recorded, but also the parts of the signal to which they relate. Data associated with that part of the signal can also be stored, and this enables the remainder of the signal to be discarded, if desired.

The invention also provides a system for analysing and annotating time-varying signals, comprising a printer for printing a time-varying signal over the substrate of the invention, and a reading and writing device for reading a local background pattern and writing on the substrate, the reading and writing device enabling the position of annotations on the substrate to be determined.

The invention also provides a method of printing time-varying signals, comprising printing the time-varying signal onto a substrate which carries a background pattern, in which local portions of the background pattern uniquely identify a location of the background pattern over the substrate.

The method may further comprise analyzing and annotating the signal using a reading and writing device to read a local background pattern while writing annotations on the substrate adjacent to areas of the signal of interest.

The method may further comprise using the local background pattern which has been read to derive digital timing information concerning the areas of the signal of interest.

This method enables annotations to be stored and the parts of the signal to which they relate to be identified, without changing the interface for the user. Again, this can be used for the analysis of physiological signals.

The invention also provides a computer program for collating data relating to the analysis of a time-varying signal, the computer program adapted to:

receive, from a reading and writing device, the local background pattern information from a substrate which carries a printed version of the time-varying signal;

determine the position of annotations on the substrate from the local background pattern information received;

determine a timing window corresponding to the portions of the time-varying signal adjacent the annotations; and

store the data relating to the timing window.

### BRIEF DESCRIPTION OF THE DRAWINGS

Examples of the invention will be described in detail with reference to the accompanying drawing, in which:

FIG. 1 shows the paper used in digital pen and paper technology;

FIG. 2 shows an enlarged part of the background pattern of the paper of FIG. 1;

FIG. 3 shows the pen used in digital pen and paper technology;

FIG. 4 is used to explain one way in which a dot pattern can encode position information;

FIG. 5 shows an ECG plot with a region of diagnostic interest;

FIG. 6 shows a first example of how the plot can be annotated using a system implementing the invention;

FIG. 7 shows a second example of how the plot can be annotated using a system implementing the invention;

FIG. 8 shows a third example of how the plot can be annotated using a system implementing the invention; and

FIG. 9 shows an example of a system implementing the invention.

### DETAILED DESCRIPTION

This invention relates to the use of digital pen and paper technology for the storage and analysis of time-varying physiological signals.

Before describing the invention in detail, an overview will be given of the digital pen and paper technology.

The paper used in digital pen and paper technology carries a non-uniform background pattern of dots. The pattern of dots at any location encodes location information for the location on the page. An overlying image is typically provided as a watermark so that the dots of the background pattern can be distinguished. The local dot pattern on all locations of the background pattern is unique and identifies the location. The number of different possible local dot patterns is preferably sufficiently large that a large number of different pages can be provided with different background patterns, with different local dot patterns at all locations for all pages. Thus, any local dot pattern can identify not only a position on the page, but can also identify a page of a multiple page document.

There are many known uses for digital pen and paper technology. Essentially, it has been used as a means of digitizing handwritten text and drawings at the same time that the information is being written on the paper. This provides immediate digital information for further handling and processing.

For example, the technology has been used for creating a data file providing the information which has been handwritten on a paper form. An example of this known use of the technology will first be described, to explain the technology.

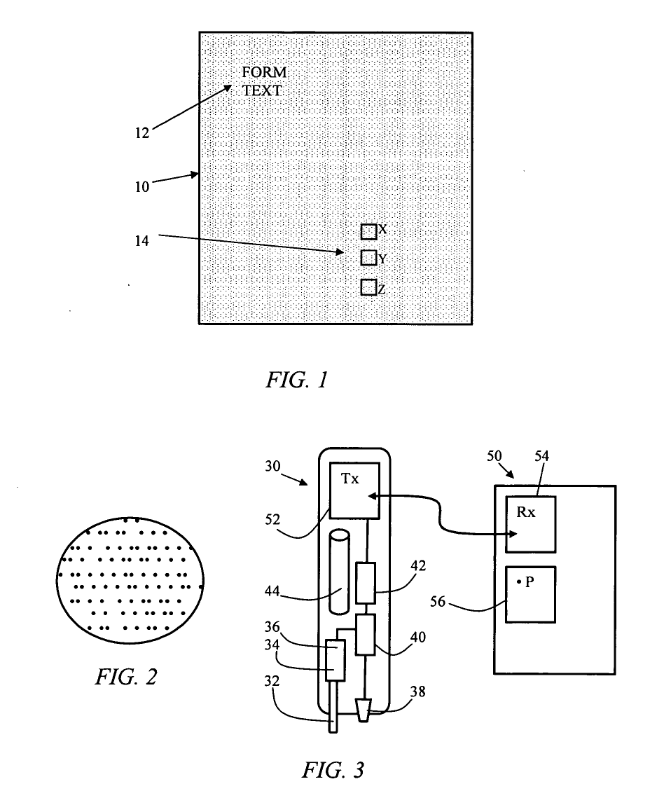

FIG. 1 shows in simplified manner a form which may be printed for use with a digital pen of a system using digital pen and paper technology.

The form 10 has text and images 12 and spaces 14 where the user is required to write to complete the form.

The form is provided on a substrate carrying the non-uniform background pattern of dots. The form is provided as a watermark so that the dots of the background pattern can still be distinguished.

To use this type of system, the user has an electronic pen for writing over the form. This pen is both a reading and a writing device, and allows the user to write over the form where he/she chooses but also identifies the locations at which markings are written by reading the local background pattern. The pen stores in a memory the dot patterns at the locations of all written markings.

This provides the user with an easy interface, where the user is simply required to write over a form in conventional manner. The system recognises the location of marks made on the form, and can additionally perform character recognition for text entries.

The technology for defining the background dot pattern and for the electronic pen is already available. For this reason, only a brief discussion of the technology will now be given.

FIG. 2 shows an enlarged part of the dot pattern. The pattern is slightly displaced from an orthogonal grid. In one example, an area of 6×6 dots gives a unique position. With each dot in one of four possible positions, this allows 4³⁶ (=2⁷²) different locations to be encoded. With dot spacing of 0.3 mm, a 6×6 dot area covers less than 2 mm×2 mm, and the overlap of 6×6 dot areas enables adjacent identifiable locations to be spaced only 0.3 mm apart.

FIG. 3 shows the digital pen and computer with which it communicates.

The pen 30 comprises a nib 32 coupled to an ink cartridge 34 and pressure sensor 36 for detecting when markings are being written. An image sensor camera 38 detects the local dot pattern. The pressure sensor and camera supply data to a processor 40. When information is being written, the pen detects this using the pressure sensor and at this time the image sensor, for example camera, detects the local dot pattern under the control of the processor 40.

The pen has a memory 42 for storing the camera information, either as recognised dot patterns or as the corresponding locations, of all written markings. The pen does not require significant processing power, but simply computes the location of the pen within the page by collecting and storing the patterns on the fly. The pen is stand alone and is powered by battery 44. The electronic pen can therefore be produced at a relatively low cost.

The information stored in the electronic pen can be downloaded into a central computer 50 having a receiver 54 and processor 56, with which the pen communicates using a transmitter 52.

In one known encoding scheme, the dot may be displaced by a fixed amount in any one of the four axial directions (i.e. up, down, left or right). Each dot thus has four possible positions. A sub-array of dots then encodes one location. This sub-array may have a variety of sizes, depending on the resolution required and the number of locations to be encoded.

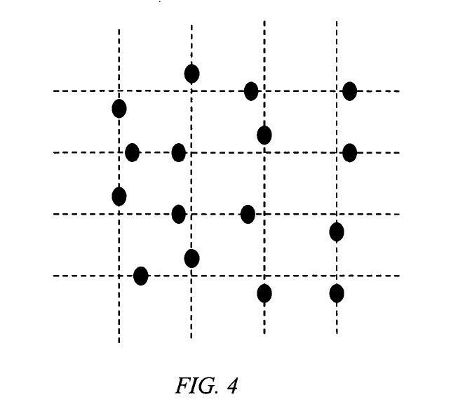

FIG. 4 shows an example of this encoding scheme, in which each dot is displaced by a fixed amount from the reference grid (in hatched lines) in one of the four axial directions. When writing with the digital pen, snapshots of the patterns are captured. Each snapshot contains enough information to calculate the exact location of the pen within the page.

This invention concerns specifically the use of this type of position encoding system to assist in the analysis of physiological time-varying information. An example of the invention will now be described for assisting the analysis of an ECG plot.

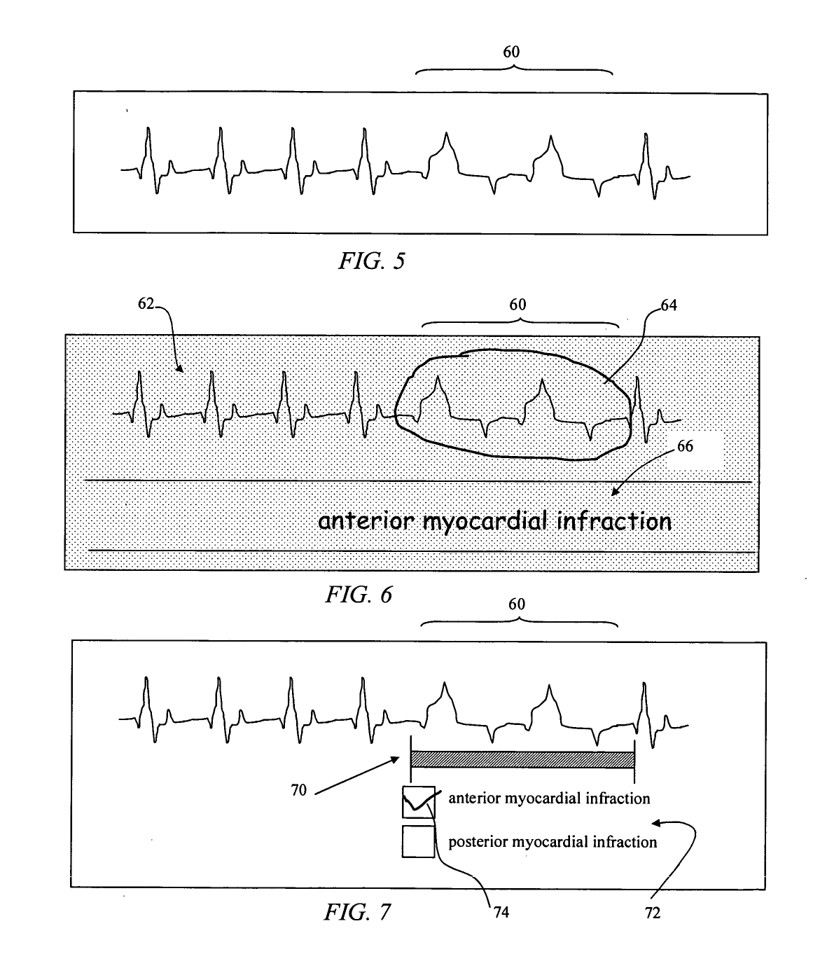

FIG. 5 shows schematically an example of an abnormal ECG plot, in which there is a region 60 of abnormality.

FIG. 6 shows the plot printed onto digital paper of the type described above. The paper thus carries a background pattern 62, in which local portions of the background pattern uniquely identify a location of the background pattern over the substrate, thereby enabling positions of annotation on the substrate which relate to portions of the physiological signal to be determined.

There are various ways in which the ability to digitally record annotations and their position can be used.

As a first example, FIG. 6 shows markings 64,66 made by a physician when examining the printout. The marking 64 identifies the region of interest and markings 66 provide comments providing diagnostic information.

The identification of the locations of the markings made enables the timing of the region of interest 60 to be determined. In particular, the printout has a time axis along the x-axis, and the position of this axis along the paper is known. The digital paper is loaded into the printer such that the point at which the printout is started (time t=0) corresponds to a known x-axis position along the paper. In this way, all location information can be used to identify a point in time for the physiological signal. This timing information can be used to delineate portions of the physiological signal which are of interest, and these time stamped intervals can then be stored digitally with an association to the annotations 66.

Part of the digital paper can be reserved for character recognition, and the text annotations 66 are placed between horizontal bars in the example shown. The timing information can be derived from the text annotations alone, which will themselves be located adjacent to the part of the physiological signal of interest.

Parts of the physiological data that may be stored include a length of time before and after the region of interest as identified in writing, as the writing marks may be centred in a region of interest and may not cover the full region of interest. The length of time which is appropriate will depend on the application, but 5-10 seconds of additional physiological signal at each side of the identified region of interest can be appropriate.

There are various known systems for automatic analysis of physiological data, and these include the automated digital analysis of ECG signals, to provide warning indications. These analysis techniques can be used in conjunction with the use of digital pen and paper technology.

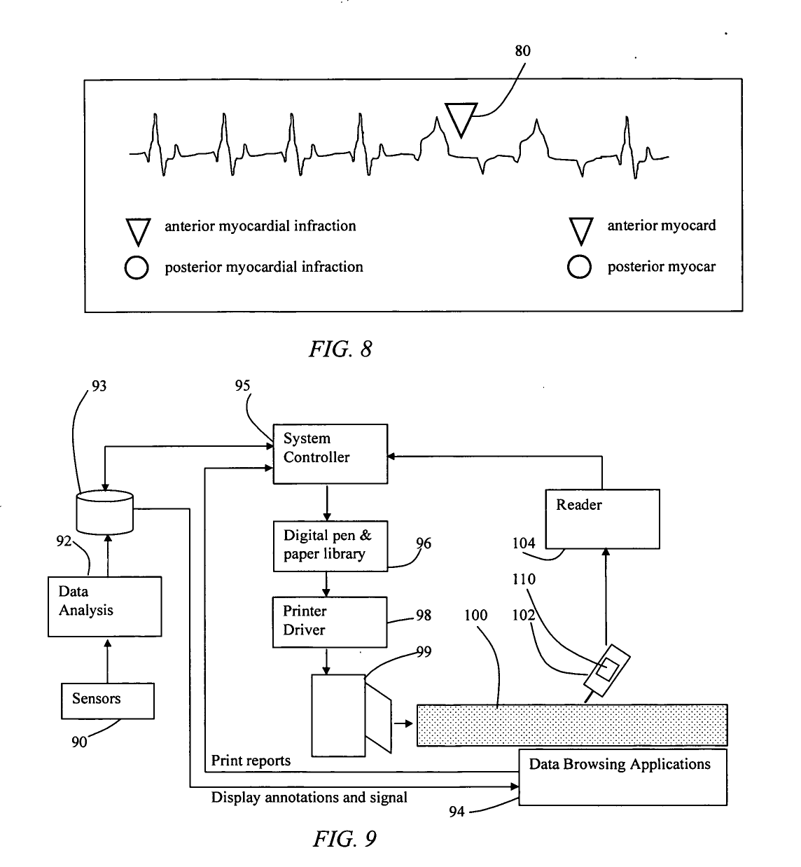

FIG. 7 shows an example of a print out for use in a system which has a processor for analyzing the physiological data before printing the data. In FIG. 7 (and FIG. 8) the background pattern of dots is not shown for simplicity. This analysis can be used to determine a portion of the signal of interest, and can then cause the printing of an identification of the portion of interest.

As shown in FIG. 7, a bar 70 is printed to identify a region of possible interest (as determined by the automatic analysis). The analytical tool can further identify possible diagnostic conclusions, and these can be printed as a selection of options, as shown at 72. These may be ordered in order of probability as determined by the analytical tool, and the physician only needs to mark a corresponding check-box, as shown at 74.

In response to the marking 74, the physiological data for the region of interest is stored together with the selected diagnosis. A space may be provided for additional (or alternative) comments, to which character recognition can be applied.

The technique for locating areas of interest, as explained with reference to FIG. 6, can also be implemented, so that further areas of interest can be identified in addition to those automatically identified.

A further alternative is to use shape recognition to enable different diagnostic conclusions to be identified. This may be more reliable than the use of character recognition.

FIG. 8 shows a printout in which a repeating key is provided, and which provides a number of shapes (only two are shown by way of example) which can be used to provide diagnostic conclusions. Again, the positions in which these shapes are recorded can be used to identify the part of the physiological signal of interest as well as the diagnostic conclusion itself. In the example shown in FIG. 8, the single marking 80 enables a window of data to be stored and associated with a particular diagnostic conclusion.

The different possible printouts shown above are only examples of possible implementations of the use of digital pen and paper technology. Other examples are possible. In each case, a simple and familiar user interface is provided to the user (physician) that enables automated digital recording of annotations (either in the form of the annotations themselves or their meaning). By annotating portions of the signal of interest, the relevant portions can be identified, and the digital data stored. This reduces the amount of digital data to be stored and also enables the paper record to be destroyed, as all the relevant signal data and annotations are stored digitally. All of this digital information can be stored with the patient's record, and can thus be distributed electronically.

The stored data can also be used for training content analysis components, namely those used to provide the analysis explained with reference to FIG. 7.

FIG. 9 shows the complete system of the invention, with the components required to implement all of the functions mentioned above. Alternatively, different implementations may use a subset of these components, and additional functions and analytical tools are also possible.

The system has a sensor or sensors 90 for capturing the time-varying physiological (or other) signal, and in the example of system shown, this data is processed by a data analysis unit 92 which performs automated analysis, to determine regions of the signal of interest, as explained above. Many such data analysis tools are commercially available for different types of physiological data, and these tools will not be described further.

The sensor signals together with automated time-stamped annotations from an application database 93 are combined for display using a data browsing application 94. This information is also provided to a system controller 95, which performs a number of functions.

The role of the system controller 95 is:
a) to extract signal data and annotations from the application database 93, and render them on paper using digital pen and paper libraries 96, and
b) to interpret the strokes collected by the pen 102, and use them to generate new (or updated) annotations, and store them into the application database 93.

The system controller 95 can be split into two separate functions for the reading and writing operations.

The rendering operation controlled by the controller 95 involves providing the data to be printed to a printer driver 98, and this data is the combination of the background pattern of dots from the library 96, the physiological plot and any additional information provided in response to the data analysis, such as indications of the regions of the plot which are considered to be of interest, and/or the list of, or key for, possible diagnostic conclusions, as explained above.

The printer driver 98 controls the printer 99 to output the plot 100, and the user makes annotations on the plot using the pen 102. As shown, the printer 99 can also be controlled to print reports generated from the data browsing applications 94.

Reader software 104 is associated with the pen 102, and there is preferably a wireless link between the pen and the computer hosting the reader software 104.

As mentioned above, the information read by the pen is provided to the system controller 95, which has access to the physiological data as well as the required protocols to interpret the dot pattern information provided by the pen.

The system controller is thus able to determine parts of the plot which are of interest, as a time window, and collates the physiological data and the corresponding annotations and/or diagnostic conclusions within the application database 93.

This combined information can be viewed subsequently using the data browsing application 94.

The system controller can perform character recognition, and/or recognition of specific shapes, as required by the specific implementation.

In the examples described above, the pen merely provides data to the system controller for analysis. However, the pen may be provided with a user feedback mechanism, such as a display, and this is shown as 110 in FIG. 9. The pen can then be used to perform quantitative measurements on the signal itself, such as determining the heartbeat frequency, or the time period between specific events in the plot. Particular pen strokes could be used to encode start and end points which the pen is able to process to derive timing values. The pen may be provided with local processing capability for this purpose, or it may communicate with the system controller in an interactive manner for this purpose. These measurement can then be displayed on the pen display (or on a display to which the information to be displayed is sent wirelessly). The measurements made could also then be recorded by the system controller as part of the data compiled by the unit 106. Alternatively, the results could be recorded by the physician on the plot for subsequent character recognition.

In all examples above, the use of character recognition may supplement rather than replace the storage of the actual captured image of the pen strokes. The captured image data could then be deleted after the character recognition output has been verified as correct.

The specific dot pattern used does not alter the applicability of the invention, and it will be known to those of ordinary skill in the art that many different dot patterns can be used for position encoding. The dot pattern does not need to be based on a rectangular grid, for example triangular or hexagonal grids may be used. Furthermore, the background pattern may not even be a pattern of dots, but may be a pattern of lines.

Only one example of data plot has been given, namely an ECG plot. However, the invention can be applied to any time-varying data plot which is to be analysed for diagnostic or other analytical purposes.

A number of examples have been given above relating to physiological signals. However, the invention can be applied to other applications, for example the annotation of signals which record the performance or operating conditions of industrial apparatus (such as speed, temperature, efficiency, power consumption etc). The analysis and recording of this information for particular time windows may be required to enable unexpected operating conditions or failures to be explained.

The invention is particularly suitable for use when the time-varying signal is printed in real time, i.e. live, or substantially real time. In other words, the signal is printed automatically as soon as it has been received and suitably processed. In practice, there will be some processing delay, but this will not be substantial. There is thus substantially continuous printing during a time period under review.

In some cases, this automatic printing of the entire signal may be by an entirely mechanical process, for example as in the case of an earthquake sensor. The pen within the printing device may be a digital pen (of the type described above) so that the printing operation provides the function of digitising the data signal itself.

The background pattern does not need to fill the printed area, and can be restricted to regions, with user input being restricted to those regions. For example, the background pattern could be in a band above or beneath the plot, and all annotations would then be restricted to the band.

Various other possibilities will be apparent to those skilled in the art.

We claim:

1. A substrate for carrying a printed time-varying signal, wherein the substrate carries a background pattern, in which local portions of the background pattern uniquely identify a location of the background pattern over the substrate, thereby enabling the position of annotations on the substrate which relate to portions of the signal to be determined.

2. A substrate as claimed in claim 1, wherein the substrate is for carrying a time-varying physiological signal.

3. A substrate as claimed in claim 1, wherein the background pattern comprises a pattern of dots, and wherein each local portion of the pattern comprises a sub-pattern of dots.

4. A substrate as claimed in claim 1, on which is printed a plurality of selection areas, each associated with a possible analytical conclusion, wherein each selection area is associated with an adjacent portion of the background pattern.

5. A substrate as claimed in claim 1, on which is printed the time-varying signal.

6. A system for analysing and annotating time-varying signals, comprising:
a substrate for carrying the time-varying signal in printed form, wherein the substrate further carries a background pattern, in which local portions of the background pattern uniquely identify a location of the background pattern over the substrate;
a printer for printing the time-varying signal over the substrate; and
a reading and writing device for reading a local background pattern and writing on the substrate, the reading and writing device enabling the position of annotations on the substrate to be determined.

7. A system as claimed in claim 6, wherein the substrate is for carrying a time-varying physiological signal.

8. A system as claimed in claim 6, wherein the system further comprises a processor for processing signals received from the reading and writing device.

9. A system as claimed in claim 8, wherein the processor is adapted to identify from the determined annotations a time window of the signal to which the annotations relate.

10. A system as claimed in claim 9, wherein the processor is further adapted to store digital data derived from the annotations, together with data representing the time window.

11. A system as claimed in claim 9, wherein the processor is further adapted to store digital data relating to the signal in the identified time window.

12. A system as claimed in claim 8, wherein the processor is further adapted to perform a shape-based recognition of the annotations made, and to identify predetermined shapes as corresponding to predetermined analytical conclusions.

13. A system as claimed in claim 12, wherein the printer is controlled to print a key of the predetermined analytical conclusions and their corresponding shapes.

14. A system as claimed in claim 6, wherein the system further comprises a processor for analyzing the data before printing the data, to determine a portion of the signal of interest, and is adapted to control the printer to print an identification of the portion of interest, together with a plurality of selection areas, each associated with a possible analytical conclusion relating to the portion of interest.

15. A system as claimed in claim 6, wherein the background pattern comprises a pattern of dots, and wherein each local portion of the pattern comprises a sub-pattern of dots.

16. A system as claimed in claim 6, wherein the reading and writing device further comprises means for analyzing timing information of the signal, and a display for displaying the analysis result to the user of the reading and writing device.

17. A method of printing time-varying signals, comprising printing the time-varying signal onto a substrate which carries a background pattern, in which local portions of the background pattern uniquely identify a location of the background pattern over the substrate.

18. A method as claimed in claim 17, further comprising analyzing and annotating the signals using a reading and writing device to read a local background pattern while writing annotations on the substrate adjacent to areas of the signal of interest.

19. A method as claimed in claim 18, further comprising using the local background pattern which has been read to derive digital timing information concerning the areas of the signal of interest.

20. A method as claimed in claim 17, wherein the step of printing comprises printing a time-varying physiological signal.

21. A method as claimed in claim 17, wherein deriving digital timing information comprises identifying from the determined annotations a time window of the signal to which the annotations relate.

22. A method as claimed in claim 21, further comprising storing the digital timing information together with data relating to the signal in the identified time window.

23. A method as claimed in claim 17, wherein using the local background pattern further comprises performing a shape-based recognition of the annotations made, thereby to identify predetermined shapes as corresponding to predetermined analytical conclusions.

24. A method as claimed in claim 17, further comprising, in a processor, analyzing the data before printing the data, thereby to determine a portion of the signal of interest, and printing an identification of the portion of interest, together with a plurality of selection options, each associated with a possible analytical conclusion determined from the analysing of the data relating to the portion of interest.

25. A method as claimed in claim 17, wherein the background pattern comprises a pattern of dots, and wherein each local portion of the pattern comprises a sub-pattern of dots.

26. A computer program for collating data relating to the analysis of a time-varying signal, the computer program adapted to:
receive, from a reading and writing device, local background pattern information from a substrate which carries a printed version of the time-varying signal;
determine the position of annotations on the substrate from the local background pattern information received;
determine a timing window corresponding to the portions of the time-varying signal adjacent to the annotations; and
store data relating to the timing window.

27. A computer program as claimed in claim 26, for collating data relating to the analysis of a time-varying physiological signal.

28. A computer program as claimed in claim 26, further adapted to store data of the time-varying signal during the timing window.
